(19) United States
(12) Patent Application Publication
(10) Pub. No.: US 2009/0275238 A1
(43) Pub. Date: Nov. 5, 2009

(54) Electrical card connector with a metal retention mechanism

(75) Inventor: Chun-Kwan Wu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION. CO., LTD.

(21) Appl. No.: 12/387,283

(22) Filed: Apr. 30, 2009

(30) Foreign Application Priority Data
Apr. 30, 2008 (CN) 200820035887.8

(51) Int. Cl. H01R 24/00

(52) U.S. Cl. 439/629

(57) ABSTRACT

A card connector, comprising: an insulative housing having a base, a pair of sidewalls protruding from two opposite sides of the base, a joint slot defined on an end of each sidewall, a retention block protruding from the outer surface on the other end of each sidewall; a plurality of contacts held within the base, the contacts having contact sections extending above the base; a metal retention mechanism having a pair of side arms with a planar section defined therebetween, a first opening and a second opening defined adjacently on each of side arms, the retention block held in the first opening; a metal cover including a top section, a second sidewall and a retention piece defined on each side of the top section cooperating with said second opening of the metal retention mechanism, each second sidewall defining a shaft section protruding into the joint slot, the retention piece held in the second sidewall when assembly.

### BACKGROUND OF THE INVENTION

1. Field of the invention

The present invention relates to an electrical card connector, and more particularly, to an electrical card connector provided with a metal retention mechanism for ensuring a more stable retention between a metal cover and an insulative housing.

2. Description of Related Art

Electrical cards are known in the art and contain intelligence in the form of a memory circuit or other electronic program. Some form of card readers retrieve the information or data stored on the card. Such cards are used in many applications in today's electronic society, including video cameras, digital still cameras, smart phones, PDAs, music players, ATMs, cable television decoders, toys, games, PC adapters, multi-media cards and other electronic applications, etc.

Example of a prior art card-receiving connectors as U.S. Pat. No. 5,996,891 of US comprises a shield shell, an insulative housing and a joint module which joint the shield shell and the insulative housing. The joint module includes a joint section defined on an end of each side of the shield shell, and a joint plate defined on the insulative housing in accordance with the joint section. The joint plate has two recesses and a beam section defined therebetween. The joint section is retained tightly in corresponding recess to ensure retention between the shield shell and the insulative housing, and to prevent the shield shell from being separated from the insulative housing by an external force. As a matter of face, the recesses are defined on the outer surface of the joint plate, and the joint section is retained through the inertia force of itself outside-in. Therefore, the retention between the joint section and the recess is not good. It is easy that the shield shell is separated with the insulative housing when an external force is exerted.

Therefore, an improved electrical card connector is desired to overcome the disadvantages of the prior arts.

### SUMMARY OF THE INVENTION

An object, therefore, of the invention is to provide a new and improved electrical card connector of the character described able to ensure the stability of the shield shell and the electrical card in the electrical card connector.

In order to achieve the above-mentioned object, an electrical card connector comprises: an insulative housing having a base, a pair of sidewalls protruding from two opposite sides of the base, a joint slot defined on an end of each sidewall, a retention block protruding from the outer surface on the other end of each sidewall; a plurality of contacts held within the base, the contacts having contact sections extending above the base; a metal retention mechanism having a pair of side arms with a planar section defined therebetween, a first opening and a second opening defined adjacently on each of side arms, the retention block held in the first opening; a metal cover including a top section, a second sidewall and a retention piece defined on each side of the top section cooperating with said second opening of the metal retention mechanism, each second sidewall defining a shaft section protruding into the joint slot, the retention piece held in the second sidewall when assembly.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled, perspective view of the present invention;

FIG. 2 is an exploded, perspective view of the electrical card connector as shown in FIG. 1;

FIG. 3 is a perspective view of an insulative housing of the electrical card connector as shown in FIG. 1; and

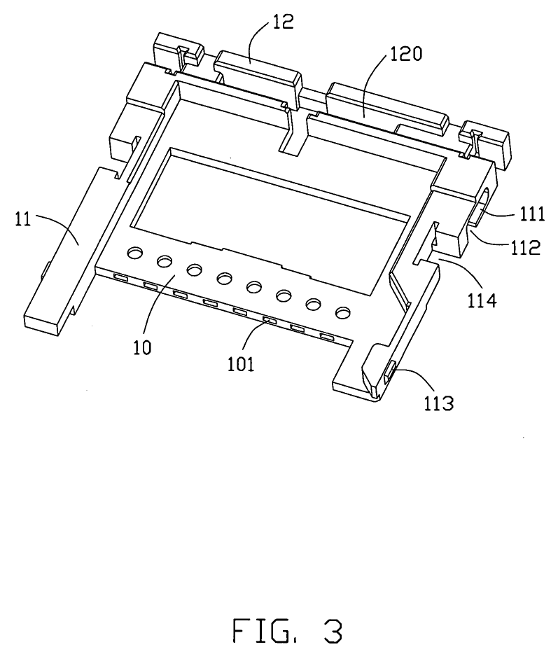

FIG. 4 is a perspective view of a retention mechanism of the electrical card connector as shown in FIG. 1.

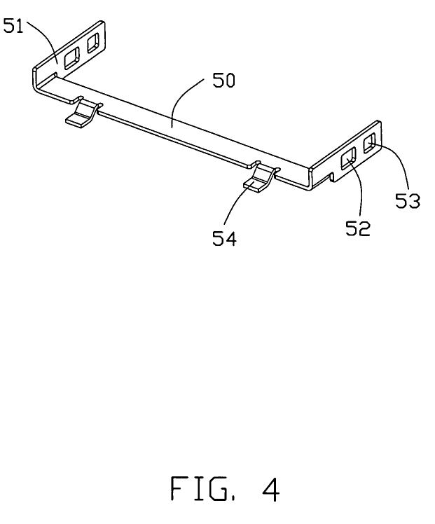

### DETAILED DESCRIPTION OF THE INVENTION

Reference will now be made in detail to the preferred embodiment of the present invention.

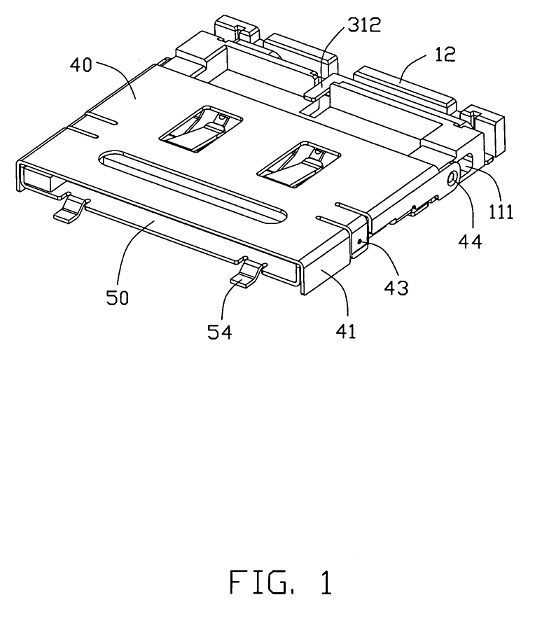

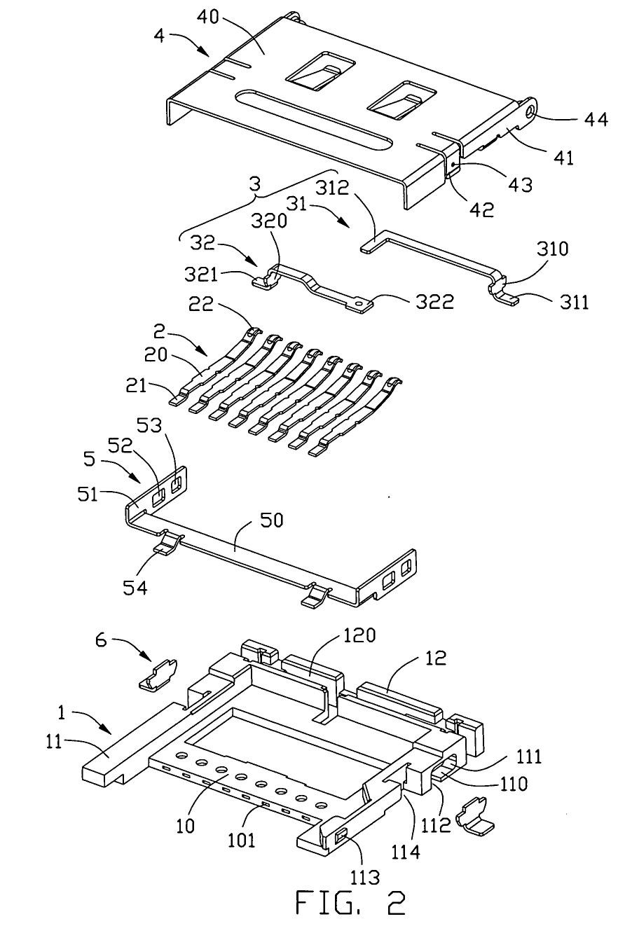

Referring to FIGS. 1-2, an embodiment of the present invention illustrated. An electrical card connector for electrically connecting an electrical card comprises an insulative housing 1 with a plurality of contacts 2 assembled therein; a detecting switch 3 defined in the insulative housing 1; a shield shell 4 covering the insulative housing 1; a retention mechanism 5 assembled on the side of the insulative housing 1; and a pair of pads 6.

The insulative housing 1 includes a base 10 with a plurality of receiving passageways 101 defined therein. A pair of sidewalls 11 extends from two opposite sides of the base 10. A back wall 12 extends from a side of the base 10 between the sidewalls 11. A recess 110 is defined on an end of each sidewall 11 near the backwall 12; a block section 113 is defined on the other end. The recess 110 defines a first position 111 and a second position 112. A receiving slot 120 is defined on the back wall 12 along the back wall 12. A notch 114 is defined on each sidewall 11 between the block section 113 and the recess 110.

Each contact 2 includes a planar section 20, and a first soldering tail 21 and a first contact section 22 are defined on two ends of the planar section 20 respectively.

The detecting switch 3 comprises a movable switch 31 and a stationary switch 32. The movable switch 31 includes a-first retention piece 310; a second soldering tail 311 and a second contact section 312 are defined on two ends of the first retention piece 310. The second soldering tail 311 and the second contact section 312 are vertical to the first retention piece 310 and extending inversely. The stationary switch 32 includes a second retention piece 320; a third soldering tail 321 and a third contact section 322 are defined on two ends of the second retention piece 320. The third soldering tail 321 and the third contact section 322 are vertical to the second retention piece 320 and extending inversely.

The shield shell 4 includes a top surface 40, a pair of side arms 41 extends from two opposite sides of the top surface 40. Each side arm 41 is divided by a retention piece 42 extending from the same side of the top surface 40. A dimple 43 is defined on the retention piece 42. Each side arm 41 has a joint section 44 defined on an end in accordance with the recess 110.

The retention mechanism 5 includes a retention plate 50, and a pair of retention arms 51 is defined on the lengthwise ends of the retention plate 50. The retention arms 51 are parallel with each other and vertical to the retention plate 50. A first cutout 52 and a second cutout 53 are defined on each retention arm 51 adjacently. The first cutout 52 and the second cutout 53 run through the retention arm 51. A pair of fourth soldering tail 54 is defined symmetrically on the retention plate 50.

After assembly, the contacts 2 are received in the receiving passageways 101. The detecting switch 3 is received in the receiving slot 120, wherein the second contact section 312 of the movable switch 31 lays over the third contact section 322 of the stationary switch 32. The pads 6 are retained in the notch 114 on the sidewalls 11. The retention mechanism 5 is assembled on the insulative housing 1 through the retention force between the recess 110 and the joint section 44. The joint section 44 is retained in the recess 110, and the joint section 44 is movable in the recess 110 along the recess 110. The retention mechanism 5 is assembled on the insulative housing 1 through the retention force between the first cutout 52 and the block section 113. The retention piece 42 can be retained with the second cutout 53 when the joint sections 44 are moved from the first position 111 to the second position 112 of the recesses 110. Therefore, the shield shell 4 is retained on the insulative housing 1 by not only the joint section 44, but also the retention piece 42. The retention force gets larger than the prior art.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card connector, comprising:
an insulative housing having a base, a pair of sidewalls protruding from two opposite sides of the base, a joint slot defined on an end of each sidewall, a retention block protruding from the outer surface on the other end of each sidewall;
a plurality of contacts held within the base, the contacts having contact sections extending above the base;
a metal retention mechanism having a pair of side arms with a planar section defined therebetween, a first opening and a second opening defined adjacently on each of side arms, the retention block held in the first opening;
a metal cover including a top section, a second sidewall and a retention piece defined on each side of the top section cooperating with said second opening of the metal retention mechanism, each second sidewall defining a shaft section protruding into the joint slot, the retention piece held in the second sidewall when assembly.

2. The card connector as described in claim 1, wherein a back wall is defined on a side of the base, a card receiving space is defined by the base, the sidewalls, the back wall and the metal cover.

3. The card connector as described in claim 1, wherein the card connector further includes a detecting switch, the detecting switch has a movable switch and a stationary switch, the back wall defines a receiving groove with the detecting switch received therein.

4. The card connector as described in claim 2, wherein the metal cover defines at least a resilient piece protruding into the card receiving space.

5. The card connector as described in claim 1, wherein a notch is defined on each of the sidewalls with a pad retained therein, the pad is soldered on the printed circuit board.

6. The card connector as described in claim 1, wherein the metal retention mechanism defines at least a soldering tail on the planar section.

7. The card connector as described in claim 1, wherein at least a dimple is defined on the retention piece.

8. A card connector, comprising:
an insulative body;
a cover pivotally assembled to the insulative body, the cover having a pair of first side holding parts;
a plurality of contacts held within the base;
an actuating member disposed between the cover and the body, the actuating member adapted to drive the cover rotatably move with respective to the body and movable horizontally between a first position and a second position;
an unitary retention element assembled to the body, the retention element having a pair of front solder pads, and a pair of second side holding parts respectively engagable with the first side holding parts.

9. The card connector as described in claim 8, wherein a dimple is defined on each first side holding part.

10. The card connector as described in claim 8, wherein the retention element has a planar section, and the front solder pads are defined on the planar section.

11. The card connector as described in claim 10, wherein the second side holding parts are defined on the ends of the planar section lengthwise.

12. The card connector as described in claim 8, wherein a receiving space is defined by the insulative body and the cover, and at least a resilient piece extend into the receiving space from the cover.

13. A card connector comprising:
an insulative housing defining a base and two side walls commonly defining a card receiving space;
a plurality of contacts disposed in the housing with contacting sections extending into the card receiving space;
a metallic cover pivotally mounted to the housing and horizontally moveable between first position where the cover is locked not to be pivotable and second position where the cover is unlocked to be pivotable;
a metallic retention mechanism attached to the housing and defining an attachment device for attachment to a printed circuit board on which the housing is mounted; wherein
the cover is retained by the retention mechanism at the first position.

14. The card connector as claimed in claim 13, wherein said cover defines a retention tab abutting against a bottom surface of the housing at the first position.

15. The card connector as claimed in claim 13, wherein the first position is closer to a card insertion opening than the second position.
